(19) United States
(12) Patent Application Publication
(10) Pub. No.: US 2026/0147294 A1
(43) Pub. Date: May 28, 2026

(54) FIXING DEVICE

(71) Applicant: CANON KABUSHIKI KAISHA, Tokyo (JP)

(72) Inventors: TAKAAKI AKAMATSU, Kanagawa (JP); HIROKI SASAME, Tokyo (JP); GOSHI OZAKI, Kanagawa (JP); TORU IMAIZUMI, Kanagawa (JP); SHOICHIRO IKEGAMI, Kanagawa (JP)

(21) Appl. No.: 19/390,358

(22) Filed: Nov. 14, 2025

(30) Foreign Application Priority Data
Nov. 26, 2024 (JP) 2024-205843

(51) Int. Cl. G03G 15/20

(52) U.S. Cl. CPC G03G 15/2032; G03G 15/2064; G03G 2215/2035

(57) ABSTRACT

A fixing device is provided that includes an endless belt, a heater, a pressure roller, and a frame. The frame includes a plurality of ribs aligned in a longitudinal direction of the pressure roller and extending in a direction intersecting the longitudinal direction and approaching the roller portion. The plurality of ribs includes a first rib, and a second rib provided at a position farther from a center of the roller portion than the first rib in the longitudinal direction. A distance between a tip of the second rib and an outer surface of the roller portion is greater than a distance between a tip of the first rib and the outer surface of the roller portion.

### BACKGROUND

### Field of the Technology

The present disclosure relates to a fixing device provided in an electrophotographic image forming apparatus.

### Description of the Related Art

Japanese Patent Laid-Open No. 2024-31208 discusses a fixing device that includes a heating unit including a heater configured to heat an inner surface of a belt, and a pressure roller that forms a nip portion with the heater via the belt, and fixes toner on a recording material.

### SUMMARY

The present disclosure provides a fixing device that overcomes shortcomings in conventional technologies.

An aspect of the present disclosure provides a fixing device configured to fix an image to a sheet, the fixing device including a belt; a heater configured to heat an inner surface of the belt; a pressure roller including a roller portion, the roller portion and the heater configured to form a nip portion via the belt, the nip portion being configured to convey the sheet; and a frame configured to rotatably support the pressure roller, the frame facing the roller portion along a longitudinal direction of the pressure roller, the frame being made of a resin. The frame includes a plurality of ribs aligned in the longitudinal direction, the frame extending in a direction intersecting the longitudinal direction and approaching the roller portion. The plurality of ribs includes a first rib and a second rib. The second rib is provided at a position farther from a center of the roller portion than the first rib, in the longitudinal direction. A distance between a tip of the second rib and an outer surface of the roller portion is greater than a distance between a tip of the first rib and the outer surface of the roller portion.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view of a fixing device according to a first embodiment.

FIG. 2 is a cross-sectional view of a fixing device according to the first embodiment.

FIG. 3 is a cross-sectional view of the fixing device according to the first embodiment.

FIG. 4 is an exploded perspective view of the fixing device according to the first embodiment.

FIG. 5A is a front view of the fixing device according to the first embodiment and FIGS. 5B, 5C, and 5D are cross-sectional views of the fixing device according to the first embodiment.

FIGS. 6A and 6B are cross-sectional views of the fixing device according to the first embodiment.

FIG. 7 is an exploded perspective view of the fixing device according to the first embodiment.

FIG. 8 is a perspective view of a lower frame according to the first embodiment.

FIG. 9 is a cross-sectional view of the fixing device according to the first embodiment.

FIGS. 10A and 10B are plan views of the fixing device according to the first embodiment.

FIG. 11 is a plan view of the fixing device according to the first embodiment.

FIG. 12 is a plan view of a fixing device according to a second embodiment.

FIG. 13 is a plan view of a fixing device according to a third embodiment.

FIG. 14 is a plan view of a fixing device according to a fourth embodiment.

FIG. 15 is a plan view of a fixing device according to a fifth embodiment.

FIG. 16 is a plan view of a fixing device according to a sixth embodiment.

### DESCRIPTION OF THE EMBODIMENTS

Embodiments of the present disclosure are described with reference to the drawings. Dimensions, materials, shapes, and relative positions of components described in the following embodiments may be changed as appropriate depending on the configuration and various conditions of a device to which the present disclosure is applied. Thus, unless otherwise specified, the scope of the present disclosure is not limited to these embodiments.

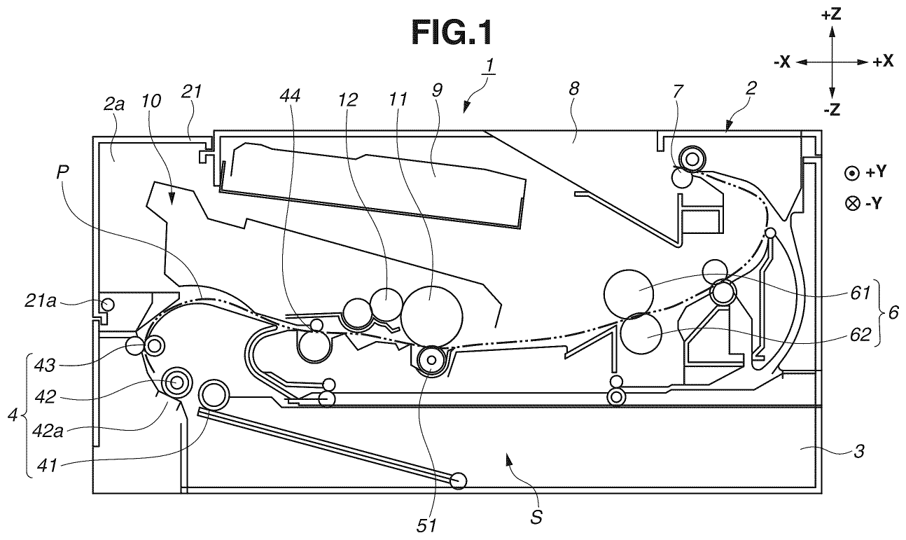

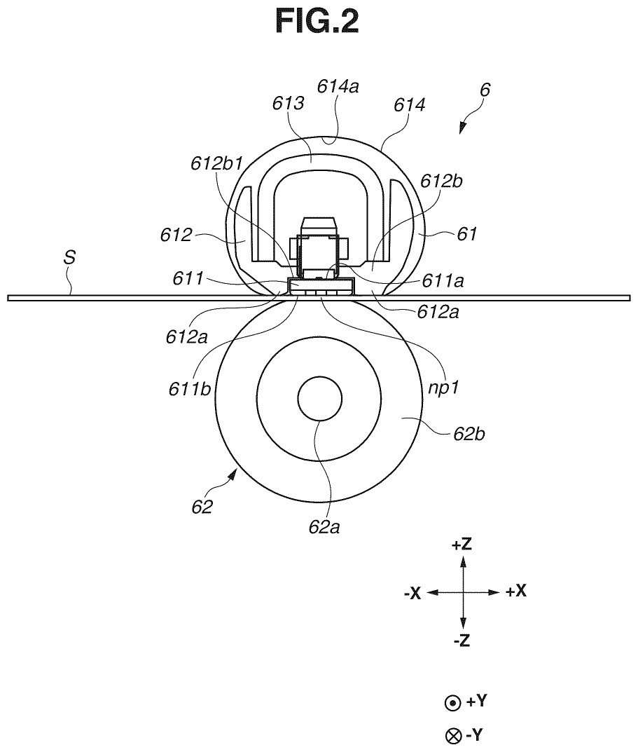

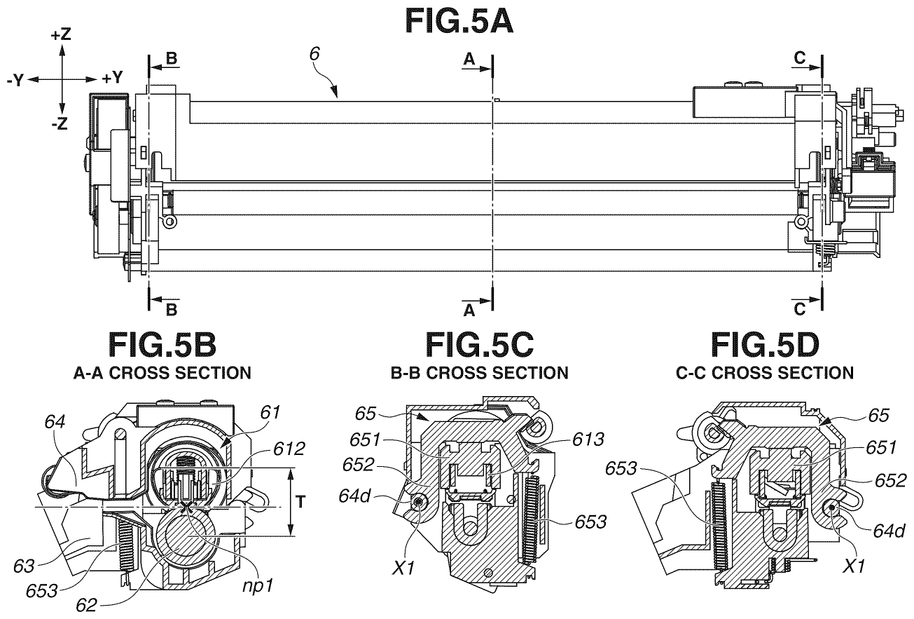

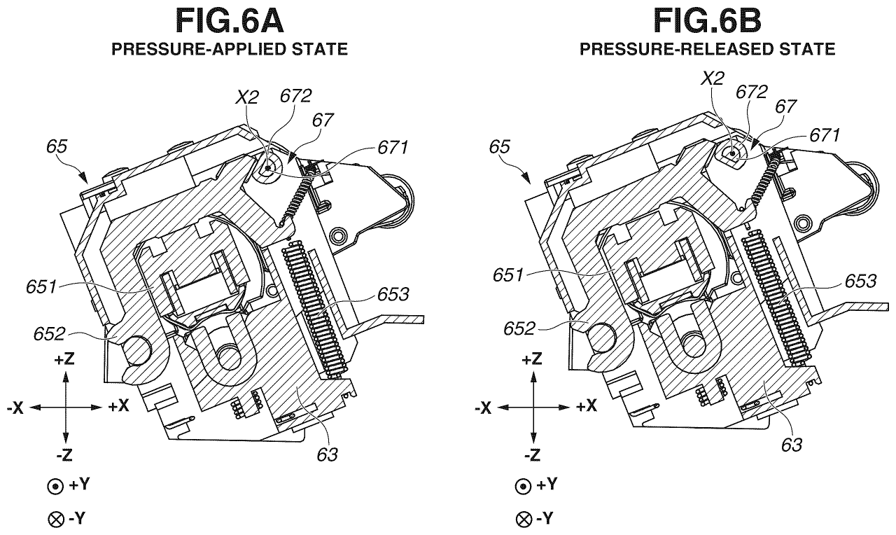

FIG. 1 is a cross-sectional view of an electrophotographic image forming apparatus 1 to which a fixing unit according to the present embodiment is applied. In the following description, as illustrated in FIG. 2, the vertical direction in a case where the image forming apparatus 1 is placed on a horizontal surface is referred to as the Z direction. The Y direction intersects the Z direction and is parallel to a rotation axis direction of a pressure arm 652, illustrated in FIGS. 5C-6B, described below. A direction intersecting both the Z direction and the Y direction is referred to as the X direction. The X direction is parallel to a direction in which a recording material at a nip portion is conveyed by a heating unit 61, described below. The X and Y directions can be horizontal directions. The X, Y, and Z directions may be orthogonal to each other. Where necessary, the directions of arrows X, Y, and Z illustrated in the drawings are referred to as a +X side, a +Y side, and a +Z side, respectively, and the opposite sides thereof will be referred to as a −X side, a −Y side, and a −Z side, respectively. In the following description, a direction in which a recording material is conveyed at a nip portion np1 described below will be referred to as a recording material conveyance direction (+X direction). The rotation axis direction of the pressure arm 652 may be referred to as an axial direction. The Y direction is a longitudinal direction of each of the heating unit 61 and a pressing rotation member 62. In the following description, the longitudinal direction of the pressing rotation member 62 may be referred to as a roller longitudinal direction (Y direction). The Y direction is also a generatrix direction of a belt 614.

### First Embodiment

A fixing device 6 according to the first embodiment will be described.

### [Image Forming Apparatus]

A configuration of the image forming apparatus 1 will be described with reference to FIG. 1. The image forming apparatus 1 includes an apparatus main body 2, a process cartridge 10, and the fixing device 6. The process cartridge 10 is detachably attached to the apparatus main body 2. The fixing device 6 is detachably attached to the apparatus main body 2. That is, the fixing device 6 is configured to be mounted on the apparatus main body 2 and may also be attached in a non-detachable manner.

The apparatus main body 2 includes a paper feed tray 3, a sheet feed unit 4, a conveyance path P, a transfer roller 51, a sheet ejection unit 7, a paper ejection tray 8, a laser scanner 9, and an opening/closing door 21. The process cartridge 10 includes a photosensitive drum 11 and a development roller 12 as a developer carrying member. The process cartridge 10 stores developer therein. The opening/closing door 21 is supported to be rotatable about a rotation shaft 21a and is movable between a closed position in which an opening portion 2a is closed and an open position in which the opening portion 2a is open. With the opening/closing door 21 in the open position with the opening portion 2a exposed, the process cartridge 10 can be attached to and detached from the apparatus main body 2 via the opening portion 2a.

The sheet feed unit 4 includes a paper feed roller 41, a separation roller 42, a separation pad 42a, and a conveyance roller pair 43. In response to a print start signal, a sheet S stored in the paper feed tray 3 is sent out to the conveyance path P by the sheet feed unit 4 and conveyed to the transfer roller 51 through a registration roller pair 44.

When the sheet S is conveyed to a predetermined position, an image formation start signal is issued to initiate an image forming process. The photosensitive drum 11 rotationally driven by a drive source (e.g., a motor) is uniformly charged to a predetermined potential by a charging unit. The surface of the photosensitive drum 11 that has been charged is exposed to light by the laser scanner 9 based on image information, and an electrostatic image is formed in which the charge in an exposed portion is removed. Toner in the process cartridge 10 is carried by the development roller 12 and supplied to the photosensitive drum 11 in accordance with an electrostatic latent image, and thereby the latent image is developed. Accordingly, the latent image is visualized on the photosensitive drum 11 as a toner image.

The transfer roller 51 is arranged to face the photosensitive drum 11 included in the process cartridge 10. When the sheet S conveyed by the registration roller pair 44 passes through the nip portion between the photosensitive drum 11 and the transfer roller 51, a voltage is applied from the apparatus main body 2 to the transfer roller 51, and the toner image on the photosensitive drum 11 is transferred to the sheet S as an unfixed image. Then, the sheet S to which the toner image is transferred is conveyed to the fixing device 6 including the heating unit 61 and the pressing rotation member 62. The fixing device 6 is a fixing device that fixes toner (developer) to a recording material. When the sheet S passes through the nip portion np1 between the heating unit 61 and the pressing rotation member 62, the unfixed image having been transferred to the sheet S is heated and pressed, and fixed to the surface of the sheet S. The sheet S to which the toner image is fixed is ejected to the paper ejection tray 8 via the sheet ejection unit 7.

### [Fixing Unit]

FIG. 2 is a cross-sectional view of the fixing device 6. As illustrated in FIG. 2, the heating unit 61 includes a heater 611, a holder 612, a stay 613, and the belt 614. The heater 611 is provided on an inner surface side of the belt 614 and heats the belt 614. The heater 611 extends in the generatrix direction (Y direction) of the belt 614 and has a flat plate shape. The heater 611 has a first surface 611a and a second surface 611b on an opposite side of the first surface 611a, and the first surface 611a is supported by the holder 612.

The second surface 611b faces the inner surface of the belt 614. The holder 612 is formed of a heat-resistant resin such as polyphenylene sulfide (PPS) or a liquid crystal polymer, and includes a guide surface 612a and a support wall 612b. The guide surface 612a is in contact with an inner peripheral surface 614a of the belt 614 and guides the belt 614. The support wall 612b has a support surface 612b1 that supports the heater 611. The support surface 612b1 of the support wall 612b is in abutment with the first surface 611a of the heater 611. In other words, since the support surface 612b1 supports the first surface 611a in the longitudinal direction of the pressing rotation member 62, the holder 612 can be said to be a heater support member.

The stay 613 supports the holder 612, and is formed by bending a plate material having greater rigidity than that of the holder 612, such as a steel plate with a thickness of 1.6 mm, into a substantially U-shape.

The belt 614 is an endless belt having heat resistance and flexibility, and includes, for example, a metal sleeve of stainless steel or the like coated with a fluororesin, or a laminate of a polyimide resin, silicone rubber, a fluororesin, and the like. The heater 611, the holder 612, and the stay 613 are arranged on the inner surface side of the belt 614, and the belt 614 is configured to rotate around these components. The inner peripheral surface 614a of the belt 614 contacts the second surface 611b of the heater 611.

The pressing rotation member 62 (pressure roller) includes a metal shaft 62a and a roller 62b that is made of an elastic material and covers the shaft 62a. The pressing rotation member 62 is configured to be pressed against the heater 611. The pressing rotation member 62 sandwiches the belt 614 between the pressing rotation member 62 and the heater 611, thereby forming the nip portion np1 configured to nip the sheet S, and apply heat and pressure thereto. That is, the pressing rotation member 62 (pressure roller) forms the nip portion np1 together with the heater 611 via the belt 614. In other words, the pressing rotation member 62 heats and presses the sheet S together with the heater 611 at the nip portion np1.

The pressing rotation member 62 is configured to rotate by receiving a driving force transmitted from a driving source provided in the image forming apparatus 1. As the pressing rotation member 62 rotates, the belt 614 rotates in a driven manner. The sheet S to which the toner image has been transferred is conveyed between the pressing rotation member 62 and the heated belt 614, whereby the toner image is thermally fixed.

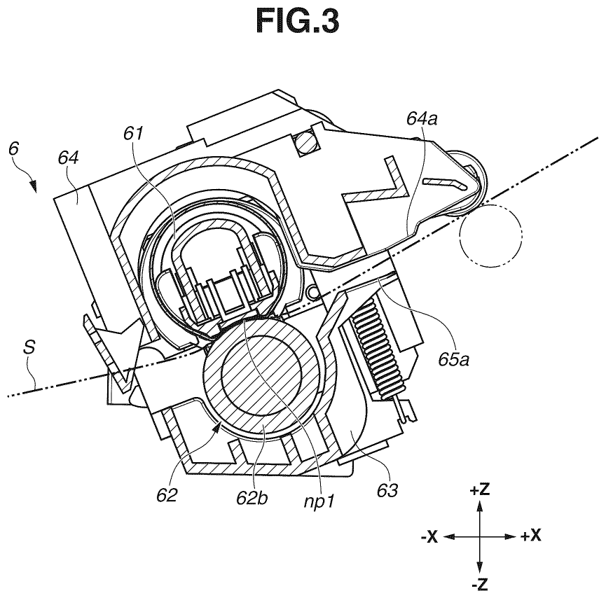

A configuration of the frame of the fixing device 6 will be described using FIG. 3. FIG. 3 is a cross-sectional view of the fixing device 6. The fixing device 6 includes an upper frame 64 and a lower frame 63. The lower frame 63 may also be referred to as a first frame, and the upper frame 64 may also be referred to as a second frame. The lower frame 63 supports the heating unit 61 and the pressing rotation member 62. The upper frame 64 is positioned above the lower frame 63 and covers the heating unit 61. The lower frame 63 and the upper frame 64 are resin members formed of a non-conductive molded member. The upper frame 64 has an upper guide surface 64a that is positioned on a downstream side of the heating unit 61 in the recording material conveyance direction (+X). The upper guide surface 64a guides the upper surface of the sheet S conveyed in the recording material conveyance direction. The lower frame 63 has a lower guide surface 65a that is positioned on the downstream side of the heating unit 61 in the recording material conveyance direction. The lower guide surface 65a guides the lower surface of the sheet S conveyed in the recording material conveyance direction.

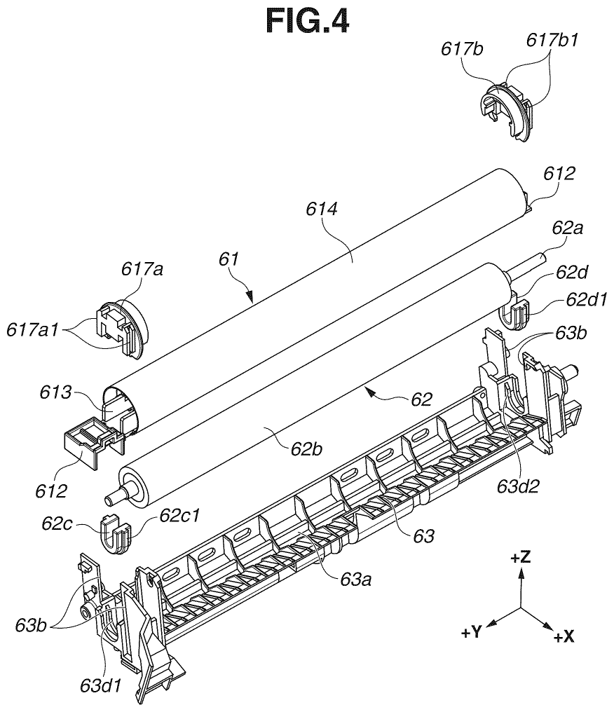

A configuration of the lower frame 63 that supports the pressing rotation member 62 is described with reference to FIG. 4. FIG. 4 is an exploded perspective view of the fixing device 6. The lower frame 63 includes a rail 63b at each end portion in a first axial direction (+Y direction) and a second axial direction (−Y direction). The rail 63b extends in a vertical direction and supports the holder 612 so as to be movable in the vertical direction. Two rails 63b face each other in the axial direction. The rails 63b engage with groove portions 617a1 and 617b1 provided in transmission members 617a and 617b, respectively. The rails 63b are guide portions that guide longitudinal ends of the heating unit 61, such that the heating unit 61 can move in a direction approaching the pressing rotation member 62.

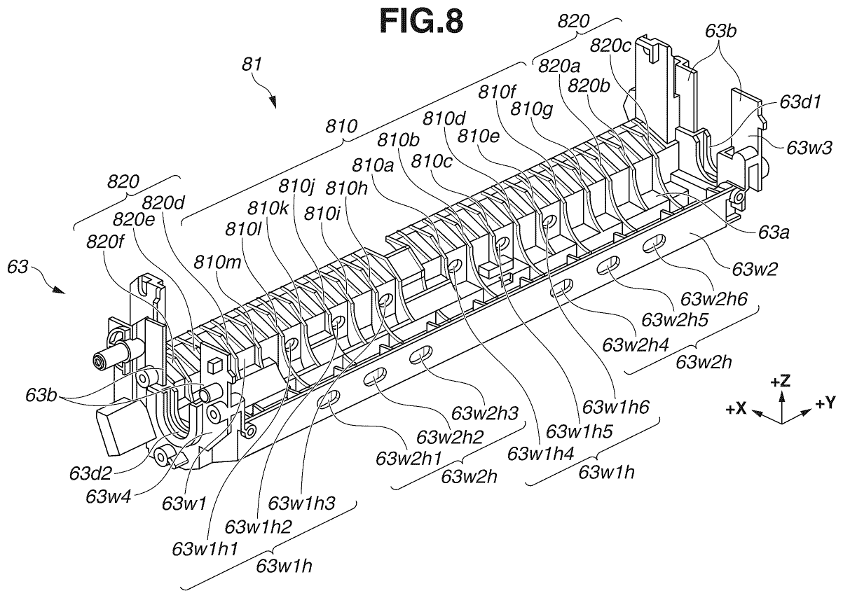

The fixing device 6 includes bearings 62c and 62d. The end portion in the first axial direction of the shaft 62a and the end portion in the second axial direction thereof are supported by the bearings 62c and 62d, respectively. The bearing 62c is positioned by being fit into a concave portion 63d1 provided in the lower frame 63. Similarly, the bearing 62d is positioned by being fit into a concave portion 63d2 provided in the lower frame 63. The concave portion 63d1 (groove portion) and the concave portion 63d2 (groove portion) extend in a direction from the heating unit 61 toward the pressing rotation member 62, and are provided in a right-side wall portion 63w3 and a left-side wall portion 63w4, respectively, as shown in FIG. 8. The concave portion 63d1 (groove portion), the concave portion 63d2 (groove portion), the bearing 62c, and the bearing 62d can be referred to as roller support portions that support the longitudinal ends of the pressing rotation member 62. The bearing 62c is electrically conductive. In this configuration, the bearings 62c and 62d are provided with convex portions, and the lower frame 63 is provided with the concave portions 63d1 and 63d2. However, a relationship between the convex and concave portions may be reversed, and the portions for fixing the bearings 62c and 62d to the lower frame 63 may have a shape other than a convex-concave shape.

### [Pressure Mechanism]

Next, a configuration of a pressure mechanism of the fixing device 6 will be described. FIG. 5A is a front view of the fixing device 6. FIGS. 5B to 5D are cross-sectional views of FIG. 5A.

As illustrated in FIG. 5, the fixing device 6 includes a pressure mechanism 65 that presses the heating unit 61 against the pressing rotation member 62. A pressure mechanism 65 is provided to the end portion in the first axial direction and a pressure mechanism 65 is provided to the end portion in the second axial direction of the lower frame 63, with the pressure mechanisms 65 supported by the lower frame 63. The pressure mechanism 65 provided on an end portion side in the first axial direction of the lower frame 63 and the pressure mechanism 65 provided on an end portion side in the second axial direction of the lower frame 63 have a substantially identical structure. Therefore, the description of the pressure mechanism 65 provided on the side in the first axial direction also applies to the pressure mechanism 65 provided on the side in the second axial direction, and thus the description of the pressure mechanism 65 provided in the second axial direction is incorporated herein by reference, for conciseness.

The pressure mechanism 65 includes a transmission member 651, the pressure arm 652, and a pressure spring 653. The pressure arm 652 is supported by the lower frame 63. More specifically, the pressure arm 652 is supported by a support portion 64d of the lower frame 63 so as to be rotatable around a central axis X1 of the support portion 64d. The support portion 64d is a substantially cylindrical projection.

The pressure arm 652 presses the transmission member 651 from above to move the transmission member 651 downward. Accordingly, the transmission member 651 presses the stay 613 downward. The transmission member 651 presses the stay 613 to move the stay 613 downward. As the stay 613 moves downward, the heating unit 61 including the stay 613 is pressed toward the pressing rotation member 62. The pressure spring 653 is a conductive tension coil spring that urges the pressure arm 652 so that the heating unit 61 is pressed against the pressing rotation member 62. The pressure spring 653 is engaged with the lower frame 63 and the pressure arm 652. As the pressure spring 653 urges the pressure arm 652, the pressure arm 652 moves the transmission member 651 downward. In other words, the pressure arm 652 presses the heating unit 61 against the pressing rotation member 62 (pressure roller).

### [Pressure Release Mechanism]

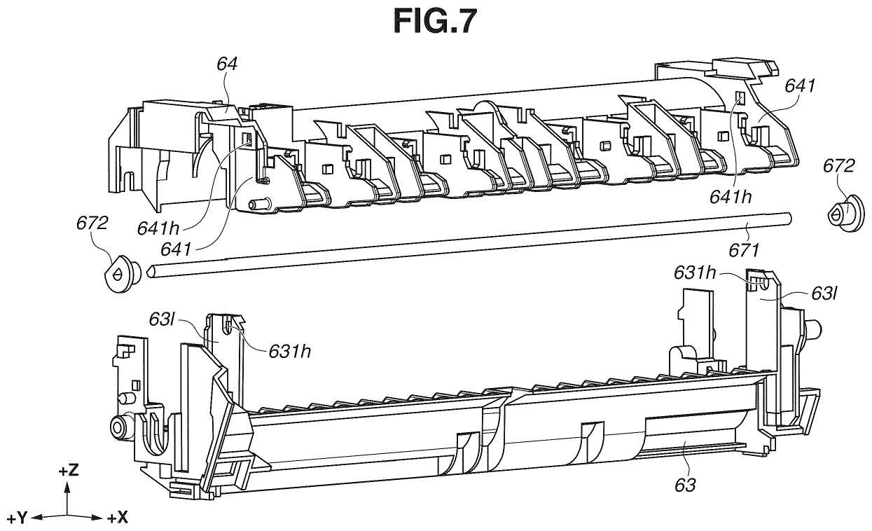

A configuration of a pressure release mechanism included in the fixing device 6 is described with reference to FIGS. 6A, 6B, and 7. FIGS. 6A and 6B are cross-sectional views of the fixing device 6. FIG. 6A illustrates a pressure-applied state in which a pressure release mechanism 67 applies pressure. FIG. 6B illustrates a pressure-released state in which the pressure release mechanism 67 releases the pressure. FIG. 7 is an exploded perspective view of the upper frame 64, the lower frame 63, and a cam shaft 671, and illustration of some components such as the heating unit 61 and the pressing rotation member 62 is omitted in FIG. 7, for clarity. The pressure release mechanism 67 is a nip pressure release mechanism that changes a nip pressure at the nip portion np1 between the heating unit 61 and the pressing rotation member 62. The pressure release mechanism 67 includes the cam shaft 671 and cams 672.

As illustrated in FIGS. 6A and 6B, the cam shaft 671 is rotatable about an axis X2. The cam shaft 671 extends in the axial direction and is made of conductive metal. As illustrated in FIG. 7, the cams 672 are fixed (supported) to an end portion of the cam shaft 671 in the first axial direction and an end portion of the cam shaft 671 in the second axial direction. The cams 672 are supported so as to rotate together with the cam shaft 671. The cams 672 are provided on an end portion side in the first axial direction of the lower frame 63 and the end portion side in the second axial direction of the lower frame 63. The cam 672 provided on the end portion side in the first axial direction of the lower frame 63 and the cam 672 provided on the end portion side in the second axial direction of the lower frame 63 have a substantially identical structure.

The cams 672 press the pressure arm 652 against an urging force of the pressure spring 653. More specifically, the rotation of the cams 672 changes a pressing force of the pressure arm 652 against the pressing rotation member 62 of the heating unit 61. The cams 672 are rotatable between a pressure-applying position illustrated in FIG. 6A and a pressure-releasing position illustrated in FIG. 6B.

To release the pressure-applied state, the cam shaft 671 is rotated, to rotate the cams 672. When the cams 672 rotate, the pressure arm 652 in abutment with the cams 672 moves from the transmission member 651 in a direction opposite to the direction in which the stay 613 is pressed by the transmission member 651.

As a result, the pressure that presses the heating unit 61 toward the pressing rotation member 62 is reduced.

A support structure of the cam shaft 671 will be described with reference to FIG. 7. The lower frame 63 includes support walls 631 that rotatably support the cam shaft 671. The support walls 631 extend in the vertical direction (Z direction). The support walls 631 have holes 631h that rotatably support the cam shaft 671. The cam shaft 671 passes through the holes 631h. In other words, the support walls 631 can also be referred to as shaft support portions that support the cam shaft 671. The support walls 631 are provided on the end portion side in the first axial direction of the lower frame 63 and on the end portion side in the second axial direction of the lower frame 63. Each of the support walls 631 is provided with the substantially identical hole 631h.

The upper frame 64 includes support walls 641 that rotatably support the cam shaft 671.

The support walls 641 extend in the vertical direction. The support walls 641 have holes 641h that rotatably support the cam shaft 671. The cam shaft 671 passes through the holes 641h. The support walls 641 are provided on the end portion side in the first axial direction of the upper frame 64 and on the end portion side in the second axial direction of the upper frame 64. The support walls 641 are provided with the substantially identical holes 641h.

### [Lower Frame]

A configuration of the lower frame 63 will be described with reference to FIG. 8. FIG. 8 is a perspective view of the lower frame 63. The lower frame 63 includes a base surface 63a, a front-side wall portion 63w1, a rear-side wall portion 63w2, the right-side wall portion 63w3, and the left-side wall portion 63w4. As illustrated in FIG. 4, the base surface 63a constitutes an upper end of the lower frame 63 and faces the roller 62b in the longitudinal direction of the roller 62b. The base surface 63a is provided with a reinforcement rib 81.

The reinforcement rib 81 will be described below. The front-side wall portion 63w1 is the end portion on a downstream side in the recording material conveyance direction (+X direction) of the lower frame 63. The front-side wall portion 63w1 extends in a direction intersecting both the roller longitudinal direction (Y direction) and the recording material conveyance direction. The surface of the front-side wall portion 63w1 on the −X direction side is part of the base surface 63a. The rear-side wall portion 63w2 is the end portion on an upstream side in the recording material conveyance direction of the lower frame 63. The rear-side wall portion 63w2 extends in a direction (Z direction) intersecting both the roller longitudinal direction (Y direction) and the recording material conveyance direction (X direction). The surface of the rear-side wall portion 63w2 on the +X direction side is part of the base surface 63a. The right-side wall portion 63w3 is the end portion on one side (+Y) of the lower frame 63 in the longitudinal direction of the pressing rotation member 62. The right-side wall portion 63w3 extends in a direction intersecting both the roller longitudinal direction and the recording material conveyance direction. The right-side wall portion 63w3 is provided with the rails 63b described above.

In the right-side wall portion 63w3, the concave portion 63d1 described above is formed. The right-side wall portion 63w3 is connected to the end portion of the base surface 63a on the +Y direction side. The left-side wall portion 63w4 is the end portion on the other (−Y) side of the lower frame 63 in the longitudinal direction of the pressing rotation member 62. The left-side wall portion 63w4 extends in a direction intersecting both the roller longitudinal direction and the recording material conveyance direction. The left-side wall portion 63w4 is provided with the rails 63b described above. In the left-side wall portion 63w4, the concave portion 63d2 described above is formed. The left-side wall portion 63w4 is connected to the end portion of the base surface 63a on the −Y direction side.

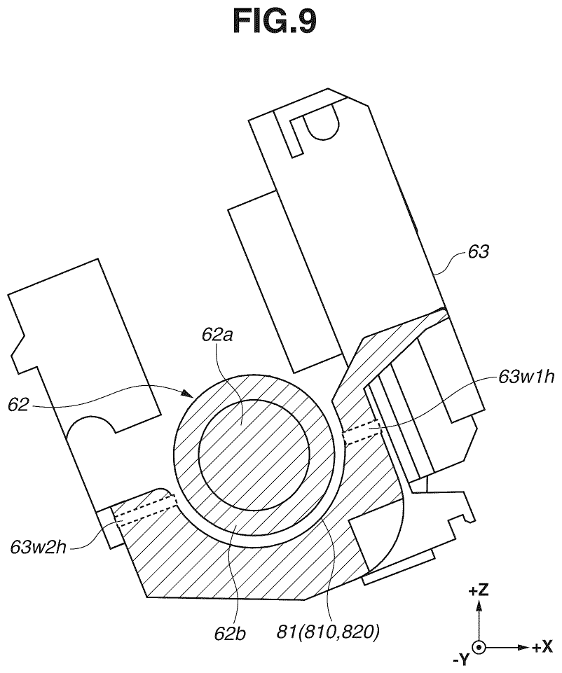

Through-holes formed in the lower frame 63 will be described with reference to FIGS. 8 and 9. FIG. 9 is a cross-sectional view of the fixing device 6. When the sheet S passes through the nip portion np1, water vapor may be generated from the sheet, and condensation may occur on the surface of the pressing rotation member 62. In such a case, a frictional force between the pressing rotation member 62 and the sheet S may decrease, and the sheet may slip, and image disturbance may ensue. Paper wrinkling may also occur. Therefore, in the present embodiment, the lower frame 63 is provided with a through-hole to suppress the occurrence of condensation. In the front-side wall portion 63w1, through-holes 63w1h that penetrate from the base surface 63a to the outside are formed. The through-holes 63w1h may be provided as a plurality of through-holes including through-holes 63w1h1 to 63w1h6, aligned in the roller longitudinal direction. The through-holes 63w1h1 to 63w1h6 are each formed between reinforcement ribs described below in the roller longitudinal direction. Through-holes 63w2h that penetrate from the base surface 63a to the outside are formed in the rear-side wall portion 63w2.

The through-holes 63w2h may be provided as a plurality of through-holes including through-holes 63w2h1 to 63w2h6. The plurality of through-holes is aligned in the roller longitudinal direction. The through-holes 63w2h1 to 63w2h6 are each formed between the reinforcement ribs, described below, in the roller longitudinal direction. As illustrated in FIG. 9, the outer surface of the pressing rotation member 62 is exposed to the outside of the fixing device via the through-hole 63w1h or the through-hole 63w2h. As described above, since the through-holes 63w1h and 63w2h are formed in the lower frame 63, it is possible to suppress stagnation of air within a space in the lower frame 63, thereby suppressing the occurrence of condensation on the surface of the pressing rotation member 62.

### [Reinforcement Ribs]

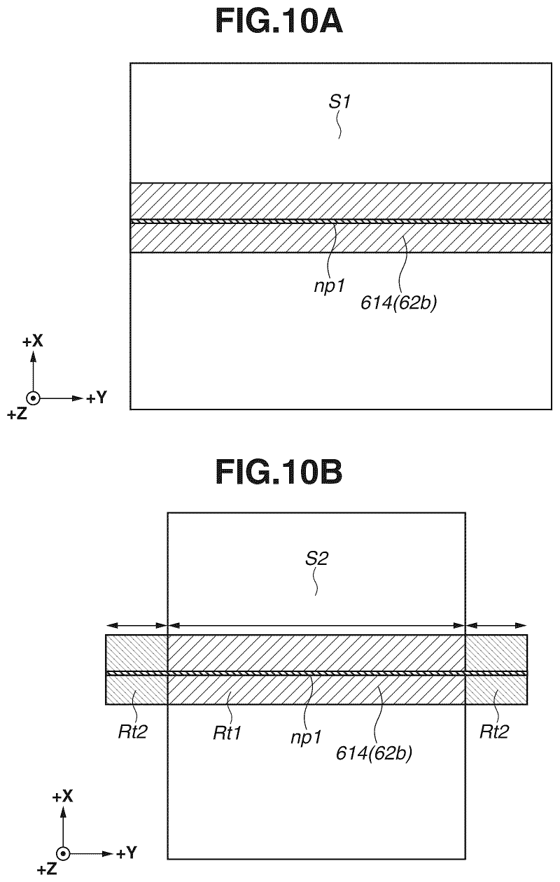

Next, the reinforcement rib 81 provided on the lower frame 63 will be described. A reason for providing the reinforcement rib 81 will be described with reference to FIGS. 10A and 10B. FIGS. 10A and 10B are plan views of the belt 614 and the roller 62b, illustrating a state in which a recording material is nipped in the nip portion np1 and is being conveyed. The sheet to be conveyed to the fixing device 6 is conveyed with a center position of the sheet aligning with the center position of the nip portion np1 in the roller longitudinal direction. The fixing device 6 can convey a plurality of types of sheets different in width in the roller longitudinal direction (Y direction). The fixing device 6 can convey a first-size sheet S1 with the maximum width that can be conveyed through the nip portion np1 in the roller longitudinal direction. The fixing device 6 can also convey a second-size sheet S2 that is narrower than the first-size sheet S1. FIG. 10A illustrates a case in which the first-size sheet S1 passes through the nip portion np1. FIG. 10B illustrates a case in which the second-size sheet S2 passes through the nip portion np1. As illustrated in FIG. 10B, when the second-size sheet S2 passes through the nip portion np1, the belt 614 and the roller 62b (roller portion) each include a passing region Rt1 through which the second-size sheet S2 passes. When the second-size sheet S2 passes through the nip portion np1, the belt 614 and the roller 62b (roller portion) each include non-passing regions Rt2 through which the second-size sheet S2 does not pass. In the non-passing regions Rt2, heat removal due to passing of the recording material does not occur. Thus, the non-passing regions Rt2 of the belt 614 and the roller 62b may be excessively heated relative to the passing region Rt1. Such a phenomenon may be referred to as a non-sheet-passing region temperature rise. When the temperatures of the belt 614 and the roller 62b are high, the heat generated from the belt 614 and the roller 62b may cause deformation of the lower frame 63, and creep deformation may occur, for example. Since the lower frame 63 according to the present embodiment is made of a resin, the lower frame 63 is more susceptible to deformation than a metal frame. Therefore, the fixing device 6 according to the present embodiment includes the reinforcement rib 81.

A configuration of the reinforcement rib 81 will be described with reference to FIG. 8. The reinforcement rib 81 is a plurality of reinforcement ribs including reinforcement ribs 810 and reinforcement ribs 820. The reinforcement ribs 810 are a plurality of reinforcement ribs including reinforcement ribs 810a to 810m. The reinforcement ribs 820 are a plurality of reinforcement ribs including reinforcement ribs 820a to 820f. More specifically, the reinforcement rib 81 includes 19 reinforcement ribs, the reinforcement ribs 810 include 13 reinforcement ribs, and the reinforcement ribs 820 include six reinforcement ribs. The reinforcement ribs 81 protrude upward from the base surface 63a. In other words, the reinforcement ribs 81 extend in a direction intersecting the roller longitudinal direction and approaching the pressing rotation member 62.

The reinforcement rib 81 is a plurality of ribs aligned in the roller longitudinal direction. As illustrated in FIG. 8, viewed in the roller longitudinal direction, the shape of a tip of the reinforcement rib 81 is an arc shape along the outer surface of the roller 62b. The arc shape does not necessarily have to be a perfect arc but may be a substantially arc shape. The nominal distance between the tip of the reinforcement rib 81 and an outer surface of the roller 62b is constant in the recording material conveyance direction.

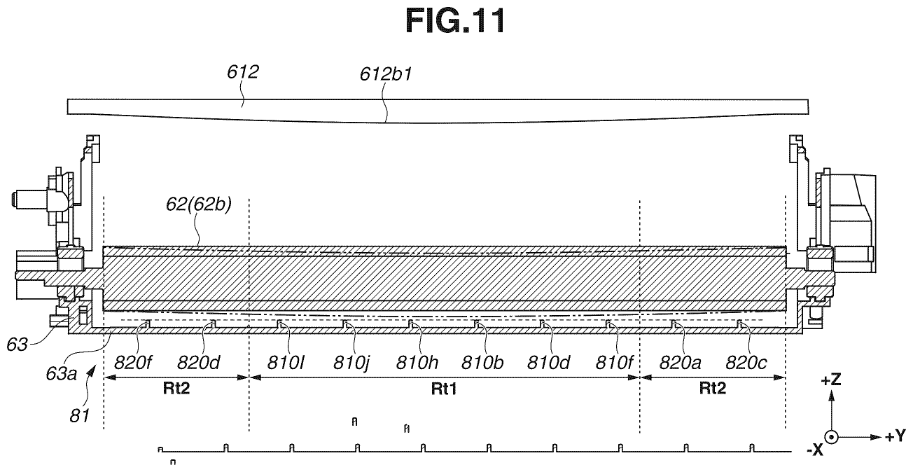

A positional relationship between the reinforcement rib 81 and the pressing rotation member 62 will be described with reference to FIG. 11. FIG. 11 is a plan view of the fixing device 6. As illustrated in FIG. 11, the reinforcement ribs 810b, 810d, 810f, 810h, 810j, and 810l are provided at positions that correspond to a part of the passing region Rt1 in the roller longitudinal direction. The reinforcement ribs 820a, 820c, 820d, and 820f are provided at positions that correspond to a part of the non-passing regions Rt2 in the roller longitudinal direction.

Any one of the reinforcement ribs 810b, 810d, 810f, 810h, 810j, and 810l may be referred to as a first rib, and such first rib is provided at a position that corresponds to a part of the passing region Rt1 in the roller longitudinal direction. Any one of the reinforcement ribs 820a, 820c, 820d, and 820f may be referred to as a second rib, and such second rib is provided at a position that corresponds to a part of the non-passing regions Rt2 in the roller longitudinal direction. In other words, the second rib is provided at a position that is farther from the center of the roller 62b (roller portion) than the first rib in the roller longitudinal direction.

The pressing rotation member 62 according to the present embodiment is a straight roller whose outer diameter is constant in the longitudinal direction, as indicated by solid lines in FIG. 11. In other words, the outer shape of the pressing rotation member 62, as indicated by the solid lines in FIG. 11, corresponds to the outer shape when the pressure release mechanism 67 is in the pressure-released state. The pressing rotation member 62 indicated by the broken lines in FIG. 11 corresponds to the shape of the pressing rotation member 62 in a first state. In the present embodiment, the first state corresponds to a state of the pressing rotation member 62, six hours after the image forming apparatus 1, including the fixing device 6, was placed in an environment with a temperature of 23° C. and a humidity of 50%, with the image forming apparatus 1 then being powered off. In a state where the image forming apparatus 1 is powered off, no power is supplied to the heater 611. In the first state, the pressure release mechanism 67 is in the pressure-applied state described above with reference to FIG. 6A. When the pressing rotation member 62 is in the first state, a distance between the surface of the pressing rotation member 62 and the base surface 63a decreases from the end portion toward the center portion of the pressing rotation member 62 in the longitudinal direction of the pressing rotation member 62. In the first state illustrated in FIG. 11, the holder 612 has a crowned shape in which the width at the center in the roller longitudinal direction is greater than the width at the end portions. The support surface 612b1 includes a region that is curved, so as to approach the pressing rotation member 62 from the end portions toward the center of the pressing rotation member 62 in the longitudinal direction.

In the present embodiment, the first rib and the second rib are configured as described below, taking into consideration that the temperature of the roller 62b becomes higher at the end portions than at the center, due to the non-sheet-passing region temperature rise. In the first state, the distance between the tip of the second rib and the outer surface of the roller 62b is greater than the distance between the tip of the first rib and the outer surface of the roller 62b. With a configuration of the height of the first rib from the base surface 63a (the length of the first rib) being equal to the height of the second rib from the base surface 63a (the length of the second rib), an influence of heat on the second rib due to the non-sheet-passing region temperature rise is reduced.

In the first embodiment, the width of the first rib in the roller longitudinal direction is identical to the width of the second rib in the roller longitudinal direction.

### Second Embodiment

Next, a second embodiment will be described. Although the pressing rotation member 62 according to the first embodiment is a straight roller, the shape of a pressing rotation member 62 according to the second embodiment is an inverse crowned shape in which the outer diameter increases from the center toward the end portions in a roller longitudinal direction. In the first embodiment, the heights of the first rib and the second rib from the base surface 63a are identical. In the second embodiment, the height of a second rib is smaller than the height of a first rib. As in the first embodiment, the distance between the outer surface of a roller 62b and the tip of the second rib is greater than the distance between the outer surface of the roller 62b and the tip of the first rib. Similarly, for the other components that are identical to those of the first embodiment, description of such components is incorporated herein by reference, for conciseness.

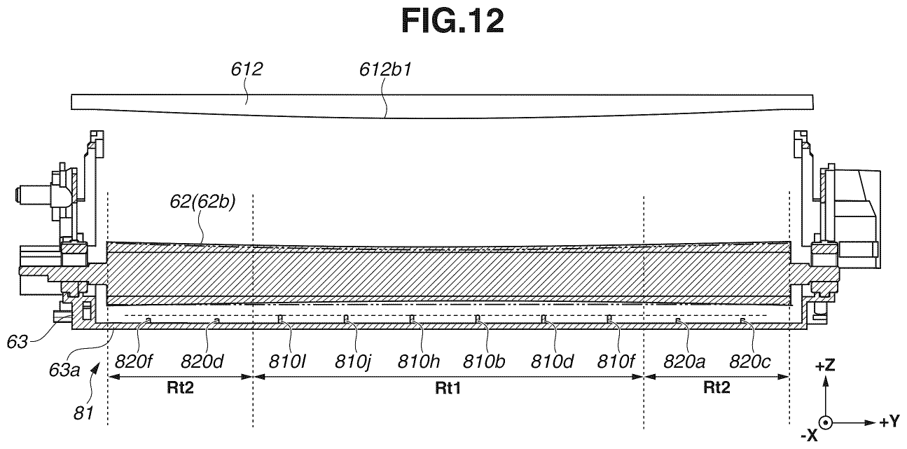

The second embodiment will be described with reference to FIG. 12. FIG. 12 is a plan view of a fixing device 6. As illustrated in FIG. 12, the pressing rotation member 62 has an inverse crowned shape, to increase the paper conveyance speed at a nip portion np1 at both longitudinal end portions of the nip portion np1 and generate a force that pulls the paper outward in the width direction, to reduce the occurrence of paper wrinkling.

The outer shape of the pressing rotation member 62 indicated by solid lines in FIG. 12 is the outer shape when the pressure release mechanism 67 is in the pressure-released state, as discussed in regard to FIG. 6B. The pressing rotation member 62 indicated by the broken lines in FIG. 12 corresponds to the shape of the pressing rotation member 62 in the first state described above. In the first embodiment, in the first state, the distance between the surface of the pressing rotation member 62 and the base surface 63a decreases from the end portions to the center of the pressing rotation member 62 in the longitudinal direction of the pressing rotation member 62. In the second embodiment, since the pressing rotation member 62 has the inverse crowned shape, the distance between the surface of the pressing rotation member 62 and a base surface 63a is constant, for example, from the end portions to the center of the pressing rotation member 62 in the longitudinal direction. Accordingly, in a case where the heights of the first rib and the second rib from the base surface 63a are identical, as in the first embodiment, the distance between the outer surface of the roller 62b and the tip of the second rib will be equal to the distance between the outer surface of the roller 62b and the tip of the first rib. Thus, since the second rib is affected by heat due to the non-sheet-passing region temperature rise, the second rib is more likely to deform than the first rib. Therefore, in the present embodiment, the height of the second rib from the base surface 63a is smaller than the height of the first rib from the base surface 63a. With this configuration, the distance between the outer surface of the roller 62b and the tip of the second rib becomes greater than the distance between the outer surface of the roller 62b and the tip of the first rib.

As described above, with the configuration according to the second embodiment, the inverse crowned shape can reduce degradation in rigidity of the lower frame 63 while reducing the occurrence of paper wrinkling.

### Third Embodiment

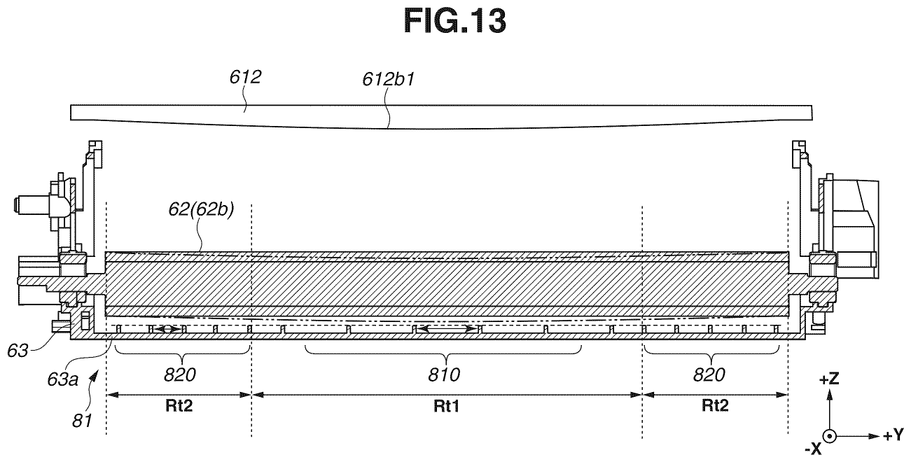

Next, a third embodiment will be described. The present embodiment differs from the first embodiment in that the number of reinforcement ribs 820 arranged in non-passing regions Rt2 is greater. The other components are identical to those of the first embodiment, and description thereof is incorporated herein by reference, for conciseness. FIG. 13 is a plan view of a fixing device 6. In the following description, any one of reinforcement ribs 810 that is located at a position corresponding to a part of a passing region Rt1 and different from a first rib in a roller longitudinal direction, and that is adjacent to the first rib, will be referred to as a third rib.

Any one of the reinforcement ribs 820, which is located at a position corresponding to a part of the non-passing regions Rt2 and different from a second rib in the roller longitudinal direction, and that is adjacent to the second rib, will be referred to as a fourth rib. As illustrated in FIG. 13, in the present embodiment, the number of reinforcement ribs 820 is increased compared to the first embodiment, and the reinforcement ribs 820 are more densely arranged than in the first embodiment. Accordingly, the distance between the second rib and the fourth rib in the roller longitudinal direction is less than the distance between the first rib and the third rib in the roller longitudinal direction. In this manner, arranging the reinforcement ribs 820 densely at positions in the non-passing regions Rt2 further reduces the influence of heat caused by a non-sheet-passing region temperature rise on a lower frame 63 compared to the first embodiment.

### Fourth Embodiment

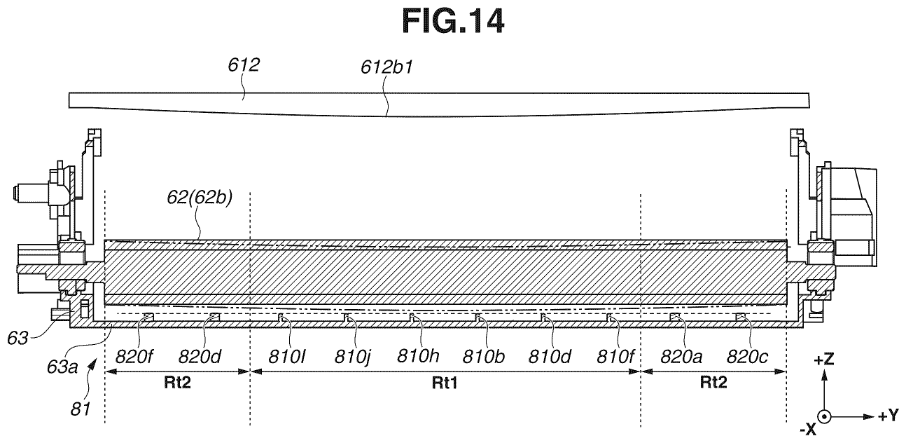

Next, a fourth embodiment will be described. The present embodiment differs from the first embodiment in that the width of a reinforcement rib 820 arranged in non-passing regions Rt2 is greater. The other components are identical to those of the first embodiment, and description is incorporated herein by reference, for conciseness. FIG. 14 is a plan view of a fixing device 6. As illustrated in FIG. 14, the width (thickness) of the reinforcement rib 820 (second rib) in a roller longitudinal direction is greater than the width (thickness) of a reinforcement rib 810 (first rib) in the roller longitudinal direction. In this manner, increasing the width (thickness) of the reinforcement rib 820 further reduces the influence of heat caused by a non-sheet-passing region temperature rise on a lower frame 63 compared to the first embodiment.

### Fifth Embodiment

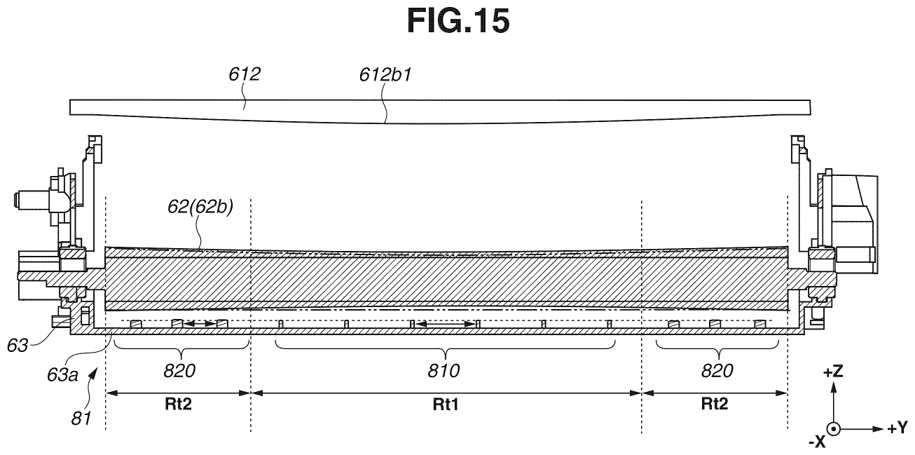

Next, a fifth embodiment will be described. FIG. 15 is a plan view of a fixing device 6. In the present embodiment, the configurations of the second to fourth embodiments are combined. More specifically, the shape of a pressing rotation member 62 is an inverse crowned shape. The distance between adjacent ribs of reinforcement ribs 820 in a roller longitudinal direction is shorter than the distance between adjacent ribs of reinforcement ribs 810 in the roller longitudinal direction. Further, the width of the reinforcement rib 820 (second rib) in the roller longitudinal direction is larger than the width of the reinforcement rib 810 (first rib) in the roller longitudinal direction. These configurations provide the advantageous effects of the second and third embodiments described above compared to the configuration of the first embodiment.

In the present embodiment, with the inverse crowned shape, it is possible to further reduce the influence of heat on a lower frame 63 due to a non-sheet-passing region temperature rise while reducing the occurrence of paper wrinkles.

### Sixth Embodiment

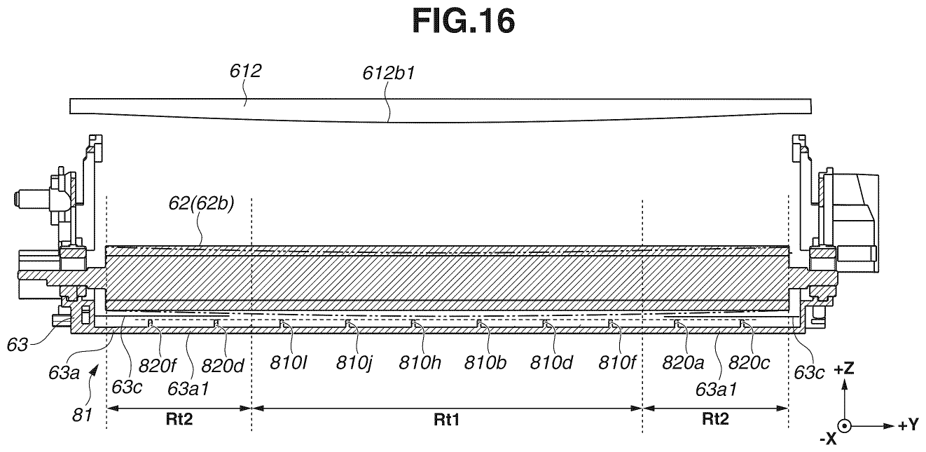

A sixth embodiment will be described with reference to FIG. 16. FIG. 16 is a plan view of a fixing device 6. A configuration of the present embodiment is different from that of the first embodiment in that the fixing device 6 according to the present embodiment includes shielding members 63c. The other components are identical to those of the first embodiment, and description thereof is incorporated herein by reference for conciseness. Facing regions (base surface 63a) of the frame that correspond to non-passing regions Rt2 of a roller 62b in a roller longitudinal direction are referred to as facing regions 63a1. The shielding members 63c are arranged between the roller 62b and the facing regions 63a1 to shield a lower frame 63 from heat from a pressing rotation member 62. In this manner, adding the shielding members 63c to the configuration of the first embodiment further reduces the influence of heat on the lower frame 63 due to the non-sheet-passing region temperature rise.

The shielding member 63c may be added to the fixing devices 6 according to the second to fifth embodiments.

The numbers, shapes, and arrangements of the reinforcement ribs 81, 810, and 820 in the first to sixth embodiments are merely examples, and may be changed as appropriate for reasons such as increasing the rigidity of the lower frame 63.

According to the present disclosure, a fixing device having a new form is provided that is an improvement over conventional technologies.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-205843, filed Nov. 26, 2024, which is hereby incorporated by reference herein in its entirety.

What is claimed is:

1. A device configured to fix an image to a sheet, the device comprising:
an endless belt;
a heater configured to heat an inner surface of the belt;
a pressure roller including a roller portion, the roller portion and the heater configured to form a nip portion via the belt, the nip portion being configured to convey the sheet; and
a frame configured to rotatably support the pressure roller, the frame facing the roller portion along a longitudinal direction of the pressure roller, the frame being made of a resin,
wherein the frame includes a plurality of ribs aligned in the longitudinal direction, the frame extending in a direction intersecting the longitudinal direction and approaching the roller portion,
wherein the plurality of ribs includes a first rib and a second rib,
wherein the second rib is provided at a position farther from a center of the roller portion than the first rib, in the longitudinal direction, and
wherein a distance between a tip of the second rib and an outer surface of the roller portion is greater than a distance between a tip of the first rib and the outer surface of the roller portion.

2. The device according to claim 1, further comprising:
a base surface of the frame,
wherein the first rib and the second rib are provided on the base surface, and
wherein a height of the second rib from the base surface is less than a height of the first rib from the base surface, in the direction intersecting the longitudinal direction.

3. The device according to claim 1, wherein a thickness of the second rib is greater than a thickness of the first rib, in the longitudinal direction.

4. The device according to claim 1,
wherein the roller portion includes a passing region configured for a second-size sheet to pass through and a non-passing region configured to preclude pass through of the second-size sheet,
wherein a width of the second-size sheet is narrower than a width of a first-size sheet having a maximum width that can be conveyed through the nip portion,
wherein the first rib is provided at a position corresponding to a part of the passing region in the longitudinal direction, and
wherein the second rib is provided at a position corresponding to a part of the non-passing region in the longitudinal direction.

5. The device according to claim 4,
wherein a third rib of the plurality of ribs is provided at a position corresponding to a part of the passing region, adjacent to the first rib in the longitudinal direction,
wherein a fourth rib of the plurality of ribs is provided at a position corresponding to a part of the non-passing region, adjacent to the second rib in the longitudinal direction, and
wherein a distance between the second rib and the fourth rib in the longitudinal direction is less than a distance between the first rib and the third rib in the longitudinal direction.

6. The device according to claim 1,
wherein, viewed in the longitudinal direction, the tip of the first rib has an arc shape that follows an outer surface of the roller portion, and
wherein, viewed in the longitudinal direction, the tip of the second rib has an arc shape that follows the outer surface of the roller portion.

7. The device according to claim 1, further comprising:
a pressure spring;
a heating unit; and
a side wall portion,
wherein heating unit includes the heater and the belt,
wherein the side wall portion is provided at an end portion of the frame in the longitudinal direction, the side wall portion extending in the direction intersecting the longitudinal direction,
wherein the side wall portion includes a roller support portion configured to support a longitudinal end portion of the pressure roller, and a guide portion configured to guide a longitudinal end portion of the heating unit such that the heating unit is movable in a direction approaching the pressure roller, and
wherein the pressure spring is configured to urge the longitudinal end portion to press the heating unit toward the pressure roller.

8. The device according to claim 7,
wherein the roller support portion and the guide portion are groove portions provided in the side wall portion, and
wherein the groove portions extend from the heating unit toward the pressure roller.

9. The device according to claim 1, wherein the frame has a through hole between the first rib and the second rib, in the longitudinal direction.

10. The device according to claim 9, wherein an outer surface of the pressure roller is exposed to outside of the device through the through hole.

11. The device according to claim 4, further comprising:
a shielding member; and
a base surface of the frame,
wherein the first rib and the second rib are provided on the base surface, and
wherein the shielding member is located at a position corresponding to at least a part of the non-passing region of the pressure roller in the longitudinal direction, between the base surface and the pressure roller.

12. The device according to claim 1, wherein at least a region of the roller portion has an outer diameter that increases from the center toward an end portion, in the longitudinal direction.

13. The device according to claim 1, further comprising:
a heater support member,
wherein the heater has a first surface facing the inner surface of the belt and a second surface on an opposite side of the first surface,
wherein the heater support member includes a support surface configured to support the second surface in the longitudinal direction,
wherein the support surface includes a region curved to approach the pressure roller from an end portion toward a center portion in the longitudinal direction, and
wherein the roller portion is straight along the longitudinal direction, with a constant outer diameter.
